(19) United States
(12) Patent Application Publication
(10) Pub. No.: US 2008/0165348 A1
(43) Pub. Date: Jul. 10, 2008

(54) APPARATUS FOR MONITORING OPTICAL FIBER LINK

(76) Inventors: Hoon Kim, Suwon-si (KR); Jae-Hun Cho, Suwon-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(21) Appl. No.: 11/967,311

(22) Filed: Dec. 31, 2007

(30) Foreign Application Priority Data
Jan. 4, 2007 (KR) 1071/2007

(51) Int. Cl. G01N 21/00

(52) U.S. Cl. 356/73.1

(57) ABSTRACT

An apparatus and method for monitoring an optical fiber that links a first node and a second node. An apparatus includes: a first transmitting part for outputting a first check light, which is modulated by the first pattern signal, to the optical fiber link. A first receiving part demodulates the second pattern signal from the second check light, which is input by the optical fiber link. A first processor generates the first pattern signal and outputs the first pattern signal to the first transmitting part, and receives the second pattern signal from the first receiving part.

### CLAIM OF PRIORITY

This application claims the benefit of priority under 35 U.S.C. §119(a) from an application entitled “Apparatus for Monitoring Optical Fiber Link,” filed in the Korean Intellectual Property Office on Jan. 4, 2007 and assigned Serial No. 2007-1071, the contents of which are hereby incorporated by reference in its entirety.

### BACKGROUND OF THE INVENTION

1. Field of the Invention

The present invention relates to an apparatus for monitoring optical fiber links. More particularly, the present invention relates to an apparatus for monitoring an optical fiber link linking a first node and a second node of a optical network, and monitoring the failure of an optical fiber.

2. Description of the Related Art

An optical time domain reflectometer (OTDR) has been generally used as a conventional apparatus for monitoring the failures (i.e., cutoff, existence or non-existence of a reflector, etc.) of an optical fiber link. The OTDR discovers the existence, the location, and the coupling or insertion loss, etc., of a reflector in the optical fiber link by generating a check light, transmitting the generated check light to the optical fiber link, and detecting reflected light that returns from the optical fiber link. When the intensity of the reflected light is abnormally high, the OTDR determines that the corresponding reflector is a cut surface of the optical fiber.

FIG. 1 illustrates an optical network including a conventional OTDR. The optical network 100 includes a first node and a second node, which are connected with each other by an optical fiber link 130. The first node includes an optical transmitter (TX) 112, an OTDR 114, and the first wavelength division multiplexer (WDM) 116. The second node 120 includes an optical receiver (RX) 124 and the second WDM 122.

The optical transmitter TX 112 generates and outputs a data-modulated optical signal, and the OTDR 114 generates and outputs a check light. In this case, the optical signal and the check light have different wavelengths. The first WDM 116 multiplexes the optical signal and the check light input therein, and outputs a multiplexed signal comprised of the optical signal and the check light along the optical fiber link 130. The second WDM 122 receives the multiplexed signal and performs a demultiplexing function so as to extract the optical signal and the check light from the optical fiber link 130, output the optical signal to the RX 124, and extinguish the check light. The RX 124 demodulates data from the optical signal received from the second WDM 122. The first and second WDMs 116, 122 and the RX 124, which are arranged on the optical fiber link 130, function as a reflector for the check light. The lights reflected from the first and second WDMs 116, 122 and the RX 124 are input into the OTDR 114 either directly or via the first WDM 116.

The OTDR 114 detects the location of a corresponding reflector on the basis of the reception time of each reflected light corresponding to a part of the check light, and also discovers the coupling or insertion loss of the reflector and whether or not the optical fiber link 130 is cut, based on the intensity of the reflected light received.

FIG. 2 illustrates a reception characteristic of the receiving power vs. distance of the OTDR. As illustrated above, the reflected lights from the first and second WDMs 116, 122 and the RX 124 are input to the OTDR 114. Based on the receiving power of the reflected light, the OTDR 114 calculates a time T1 between the of time of receiving each reflected light and the time of outputting the check light, and detects the location of the corresponding reflector, the coupling or insertion loss of the reflector and whether or not the optical fiber link 130 is cut.

However, the aforementioned optical fiber link monitoring apparatus 100 has at least the following problems:

First, as the intensity of a reflected light is very low, the OTDR 114 must include an expensive optical detector having a high reception sensitivity for an accurate determination of the receiving power. Additionally, there is a limit in that as the optical fiber link 130 should have a very small transmission loss, it can be difficult to distinguish between the reflected light and noise.

Second, as the output of the OTDR 114 is very high, the problem of crosstalk with the light signal may be caused by the stimulated Raman scattering of the reflected light, etc.

Third, as the OTDR 114 is very expensive and the intensity of the reflected light is low, there is a problem in that an accuracy in measuring the length of the optical fiber link 130 is low.

### SUMMARY OF THE INVENTION

Accordingly, the present invention has been made in part at least to solve some of the above-mentioned problems occurring in the art. Therefore, the present invention provides an optical fiber link monitoring apparatus, which can be implemented at a low price, and improves the accuracy of measuring the length of an optical fiber while minimizing the effects of noise on the measurement.

In accordance with an exemplary aspect of the present invention, there is provided an apparatus and method for monitoring an optical fiber link linking the first node and the second node according to the present invention, the apparatus typically comprising: a first transmitting part for outputting a first check light, which is modulated by the first pattern signal, to the optical fiber link; a first receiving part for demodulating a second pattern signal from the second check light, which is input by the optical fiber link; and a first processor for generating the first pattern signal and outputting the first pattern signal to the first transmitting part, and receiving the second pattern signal from the first receiving part.

### BRIEF DESCRIPTION OF THE DRAWINGS

The above and other aspects, features and advantages of the present invention will be more apparent from the following detailed description taken in conjunction with the accompanying drawings, in which:

FIG. 1 is a view illustrating an optical network including a conventional OTDR;

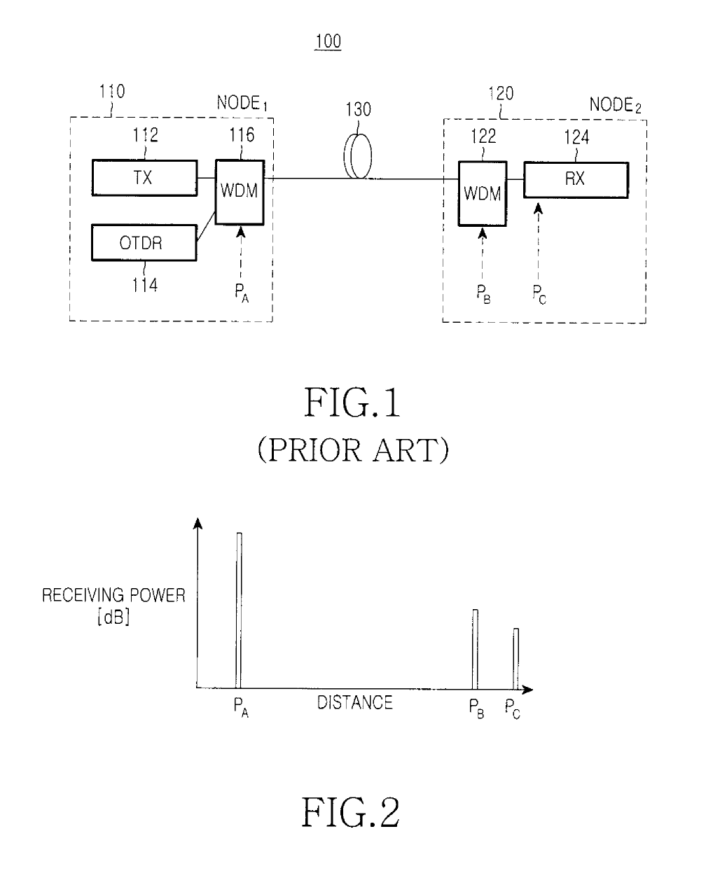

FIG. 2 is a view describing the reception characteristic of the OTDR illustrated in FIG. 1;

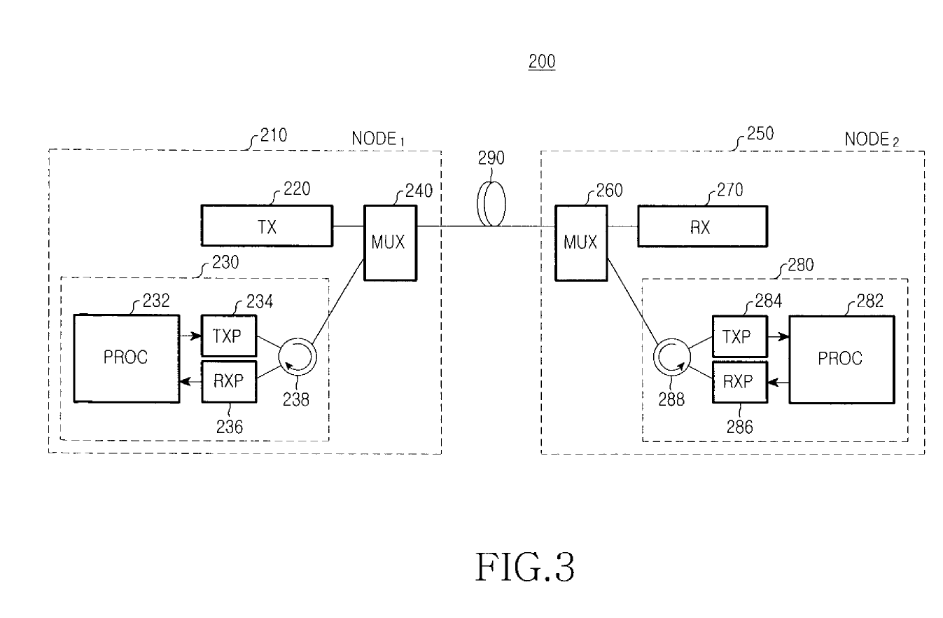

FIG. 3 is a view illustrating an optical network including an optical fiber monitoring apparatus according to an exemplary embodiment of the present invention; and

FIGS. 4 and 5 are views describing a procedure of pattern change of the first processor illustrated in FIG. 3.

### DETAILED DESCRIPTION OF THE INVENTION

Hereinafter, an exemplary embodiment according to the present invention will be described with reference to the accompanying drawings, which have been provided for illustrative purposes and do not limit the invention to the example shown and described. For the purposes of clarity and simplicity, the detailed description of known functions and configurations incorporated herein may be omitted so as not to obscure appreciation of the subject matter of the present invention by a person of ordinary skill in the art.

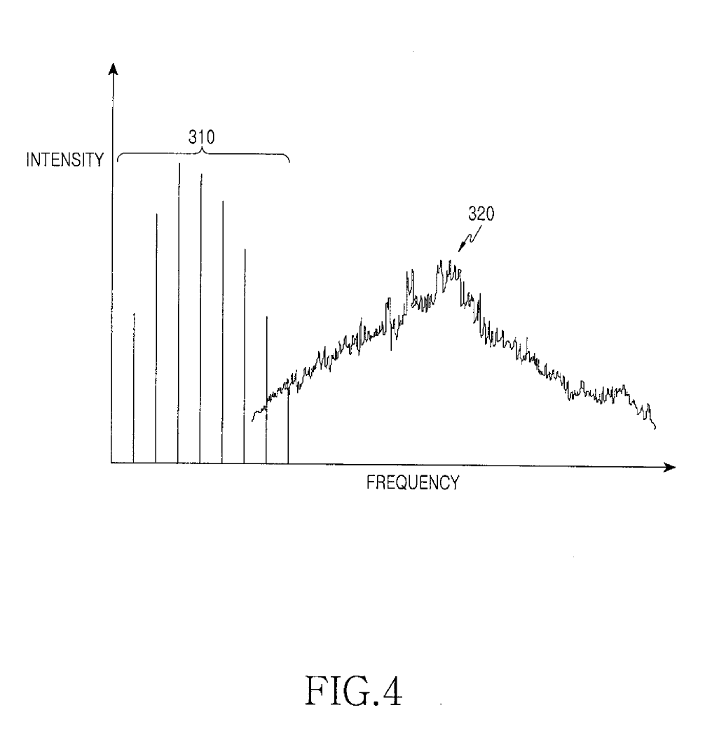

FIG. 3 illustrates an exemplary configuration of an optical network including an optical fiber monitoring apparatus according to an exemplary embodiment of the present invention. The optical network 200 typically includes a first node 210 and a second node 250, which are linked by an optical fiber link 290.

Still referring to FIG. 3, the first node 210 includes an optical transmitter 220, a first optical fiber monitoring apparatus 230 and a first multiplexer (MUX) 240, and the second node 250 includes an optical receiver 270, a second optical fiber monitoring apparatus 280 and a second MUX 260.

The optical transmitter 220 generates and outputs a data-modulated optical signal. The data above may be, for example, Internet communication data, broadcasting data, etc., and so forth. The modulation scheme typically includes but is not limited to intensity modulation and polarization modulation, etc. The optical transmitter 220 includes a light source, such as, for example, a laser diode or a light emitting diode.

The first optical fiber monitoring apparatus 230 generates and outputs a first check light, and receives a second check light and reflected light. Here, while the optical signal and the first and the second check lights have different wavelengths, the first and the second check lights have the same wavelength. The first optical fiber monitoring apparatus 230 includes a first transmitting part (TXP) 234, a first receiving part (RXP) 236, a first optical distributor 238 and a first processor (PROC) 232.

As shown in FIG. 3, the first TXP 234 generates and outputs the first check light modulated by the first pattern signal input from the first PROC 232. The first pattern signal comprises a digital bit stream. The first pattern signal includes a predetermined pattern between the second optical fiber monitoring apparatus 280 and the first pattern signal. For example, the first pattern signal may be a bit stream of ‘1100111100110000’. The modulation scheme includes intensity modulation and polarization modulation, etc. The first TXP 234 and a second TXP 284 include a light source, for example, a laser diode or a light emitting diode, respectively.

The first RXP 236 demodulates the second pattern signal received from the second check light input by the first optical distributor 238, and also demodulates the first pattern signal from the reflected light input by the first optical distributor 238. The second pattern signal is different from the first pattern signal. The second pattern signal is a digital bit stream, and includes a predetermined pattern between the second optical fiber monitoring apparatus 280 and the second pattern signal. For example, the second pattern signal may be a bit stream of ‘0011000011001111’. The stream could be longer, shorter, or any other variation of 0s and 1s. The first RXP 236 and the second RXP 286 each include an optical detector, such as, for example, a photo diode, respectively.

The first optical distributor 238 outputs the first check light, which is input from the first TXP 234, to the first MUX 240, and also outputs the second check light or the reflected light, which are received from the first MUX 240, to the first RXP 236. According to an exemplary embodiment of the present invention, the first optical distributor 238 and the second optical distributor 288 may use a wavelength-independent optical circulator and a wavelength-dependent directional coupler and so on, respectively.

The first MUX 240 multiplexes the light signal input from the optical transmitter 220 and the first check light input from the first optical distributor 238, and outputs the multiplexed signal to the optical fiber link 290. The first MUX 240 also receives the second check light and the reflected light, which are input over the optical fiber link 290, and outputs the second check light and reflected light to the first optical distributor 238. The first MUX 240 and the second MUX 260 can use, for example, an arrayed waveguide grating (AWG), a WDM filter, and the like, respectively.

The first processor 232 generates the first pattern signal and outputs the generated first pattern signal to the first TXP 234, and receives the second pattern signal from the first RXP 236. The first processor 232 calculates T2, i.e., a time between the time of outputting the first pattern signal and the time of receiving the second pattern signal, in order to detect the length of the optical fiber link 290. That is, the length of the optical fiber link 290 is detected by multiplying the propagation speed of each of the check lights by T2, and by dividing a value resulting from the multiplication by 2. In this case, the delay time between each of the processors 232, 282 and corresponding MUXs 240, 260, and the processing delay time of each of the processor 232, 282, which have been already known, are excluded from the calculation. The length of the optical fiber link 290 typically corresponds to the length between the first MUX 240 and the second MUX 260. In the same manner, the reflected lights from each of the first and the second MUXs and the optical receiver 270 are input to the RXP 236. The first PROC 232 calculates the elapsed time between a time of receiving the first pattern signal demodulated from each reflected light and a time of outputting the first pattern signal, and detects the location of the corresponding reflector, the coupling or insertion loss of the reflector and whether or not the optical fiber link 290 is cut, based on the receiving power of the reflected light.

Still referring to FIG. 3, the second MUX 260 receives the optical signal, which is input from the optical fiber link 290, and is then output to the optical receiver 270, and outputs the first check light, which also received from the optical fiber link 290, to the second optical distributor 288. The second MUX 260 also receives the second check light, which is input from the second optical distributor 288, and output to the optical fiber link 290.

The optical receiver 270 demodulates the data received comprising the optical signal output from the second MUX 260. The optical receiver 270 includes an optical detector, such as a photo diode.

The second optical fiber link monitoring apparatus 280 receives the first check light, and generates and outputs the second check light. The second optical fiber link monitoring apparatus 280 includes the second TXP 284, the second RXP 286, the second optical distributor 288, and the second PROC 282.

The second optical distributor 288 outputs the first check light, which is received from the second MUX 260, to the second RXP 286, and also outputs the second check light, which is received from the second TXP 284, to the second MUX 260.

The second RXP 286 demodulates the first pattern signal from the first check light, which is input from the second optical distributor 288, and outputs the first pattern signal to the second PROC 282.

The second TXP 284 generates and outputs the second check light modulated by the second pattern signal received from the second PROC 282. The second pattern signal is a digital bit stream. The second pattern signal includes a predetermined pattern between the first optical fiber monitoring apparatus 230 and the second pattern signal.

The second PROC 282 receives the first pattern signal from the second RXP 286, and then generates the second pattern signal for output to the second TXP 284.

As described in the above exemplary configuration of the present invention, the first and second pattern signals have mutually different patterns such that it is easy to monitor the optical fiber link 290 by using the reflected light. On the contrary, when the first and second pattern signals have the same pattern, it may be difficult to distinguish between the modulated first pattern signal from the reflected light and the second pattern signal.

Moreover, when the modulation frequency of the check light and the peak frequency of the light generated from noise are mutually the same or similar to each other, crosstalk is highly likely to occur, and the signal quality (e.g., bit error rate, etc.) of the check light will be degraded by the crosstalk. Eventually, the measurement accuracy becomes low. According to the present invention, the first and second PROC 232, 282 measure the bit error rate of each corresponding pattern signal. When the bit error rate is higher than an acceptable level, at least one of the first and second PROC 232, 282 can change the pattern of the pattern signal in order to reduce the bit error rate. The first PROC 232 will be described below because the pattern change process can be equally applied to the first and the second PROC 232, 282.

An example of the change pattern process by first PROC 232 can operate as follows.

First, the first PROC 232 measures the bit error rate of the second pattern signal by comparing the second pattern signal with an already known pattern. In order to improve the accuracy, the procedure of measuring the bit error rate above may be repeated many times.

Second, the first PROC 232 increases or decreases the transfer speed of the first pattern signal when the measured bit error rate is higher than an acceptable level. The increase and decrease of the transfer speed are accomplished by a pattern change through the same bit addition or removal. For example, the first PROC changes an existing pattern ‘1100111100110000’ to a pattern ‘10110100’ or another pattern ‘11110000111111110000111100000000’. Accordingly, when the first TXP 234 has a transfer speed of 2.5 Gb/s, the transfer speed is changed to 5 Gb/s in the former case, and the transfer speed is changed to 1.25 Gb/s in the latter case.

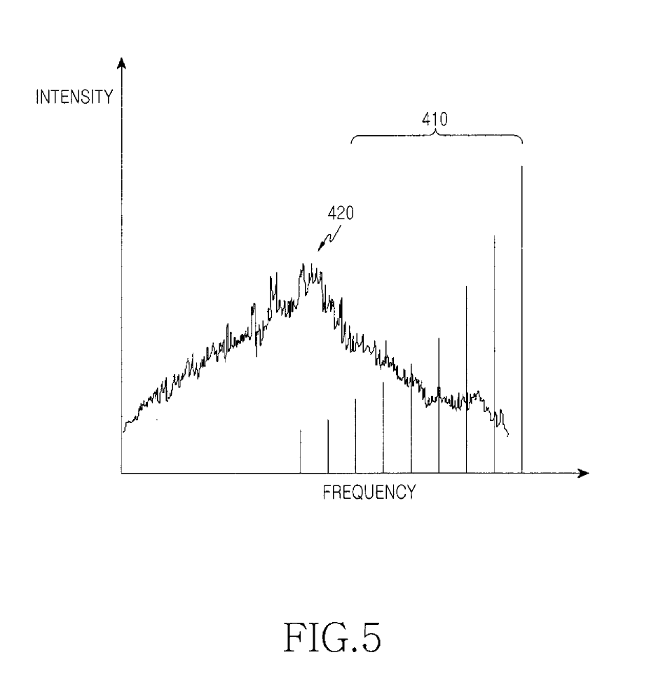

FIGS. 4 and 5 illustrate an example of the procedure of pattern change by the first PROC 232. FIGS. 4 and 5 illustrate frequency spectrums for the first check light and the noise light, respectively.

Referring to FIG. 4, the first PROC 232 may typically restrain the first check light 310 from interfering with the noise light 320 located in the high frequency band by adding the same bit in order to decrease the transfer speed (in other words, in order to reduce the modulation frequency). In this case, a low pass filter may be additionally provided between the first RXP 236 and the first PROC 232 in order to remove the noise component from the signal output by the first RXP 236.

Now, referring to FIG. 5, the first PROC 232 may typically restrain the first check light 410 from interfering with the noise light 420 located in the low frequency band by removing the same bit in order to increase the transfer speed (in other words, in order to increase the modulation frequency). In this case, a high pass filter may be additionally provided between the first RXP 236 and the first PROC 232 in order to remove the noise component from the signal output by the first RXP 236.

In the aforementioned embodiment, each of the processors 232 and 282 may use what has been already set in the corresponding nodes 210 and 250.

While the aforementioned exemplary embodiment has provided an illustration in which only the first optical fiber link monitoring apparatus 230 in the first node 210 monitors the optical fiber link 290, each of the first optical fiber link monitoring apparatus 230 in the first node 210 and/or the second optical fiber monitoring apparatus 280 in the second node 250 may monitor the optical fiber link 290, respectively.

Additionally, while a unidirectional optical network 200 in which only the first node 210 transmits the light signal has been described, the optical fiber monitoring apparatus of the present invention may be applied, for example, to other networks, such as a bidirectional optical network. To this end, the first node 210 may further include the optical receiver, and the second node 250 may further include the optical transmitter.

As described above, the optical fiber monitoring apparatus according to the present invention has advantages in that it can be implemented at a low price because it has a simple configuration, and improves the accuracy of measuring the length of the optical fiber as compared with the accuracy of a conventional apparatus by applying different check lights instead of using the reflected light, and thereby minimizes the effect of noise on a measurement by employing pattern changes.

While the optical fiber link monitoring apparatus described in the present invention is not limited to the embodiment and drawings described above, it will be understood by those skilled in the art that various substitutions, modifications and changes in form and details may be made therein without departing from the spirit of the invention and the scope of the appended claims.

What is claimed is:

1. An apparatus for monitoring an optical fiber link linking a first node and a second node, comprising:
a first optical fiber monitoring apparatus including:
a first transmitting part for outputting a first check light, which is modulated by a first pattern signal, to the optical fiber link;
a first receiving part for receiving and demodulating a second pattern signal from a second check light, which is input via the optical fiber link; and
a first processor for generating the first pattern signal and outputting the first pattern signal to the first transmitting part, and for receiving the second pattern signal from the first receiving part.

2. The apparatus of claim 1, wherein the first pattern signal and the second signal pattern are different each other.

3. The apparatus of claim 2, wherein when a bit error rate of the second pattern signal is higher than a predetermined level the first processor modifies the first pattern signal.

4. The apparatus of claim 3, wherein a transfer speed of the first pattern signal is increased or decreased when the bit error rate is higher than the predetermined level.

5. The apparatus of claim 3, wherein the first processor changes the first pattern signal by adding or removing a same bit.

6. The apparatus of claim 1, wherein the first optical fiber monitoring apparatus further comprises a first optical distributor for outputting the first check light, which is received from the first transmitting part, to the optical fiber link, and for outputting the second check light which is received from the optical fiber link, to the first receiving part.

7. The apparatus of claim 1, wherein the first processor detects the length of the optical fiber link by calculating an elapsed time between a time of outputting the first pattern signal and a time of receiving the second pattern signal.

8. The apparatus of claim 1, wherein the first processor detects the location of a reflector by calculating an elapsed time between a time of outputting the first pattern signal and a time of receiving the first pattern signal demodulated from the light reflected on the optical fiber link from among the first check lights.

9. The apparatus of claim 1, further comprising:
a second optical fiber link monitoring apparatus comprising:
a second receiving part for demodulating the first pattern signal from the first check light, which is received from the optical fiber link;
a second transmitting part for outputting the second check light, which is modulated by the second pattern signal, to the optical fiber link; and
a second processor for receiving the first pattern signal from the second receiving part and generating the second pattern signal, and for outputting the second pattern signal to the second transmitting part.

10. The apparatus of claim 9, wherein the second optical fiber link monitoring apparatus further comprises a second optical distributor for outputting the second check light, which is received from the second transmitting part, to the optical fiber link, and for outputting the first check light, which is received from the optical fiber link, to the second receiving part.

11. The apparatus of claim 1, further comprising:
an optical transmitter in the first node for generating and outputting a data-modulated optical signal; and
an optical receiver in the second node for receiving and demodulating the data-modulated optical signal transmitted from the first node.

12. The apparatus of claim 11, further comprising:
a first multiplexer/demultiplexer in the first node for multiplexing the first check light and the data-modulated optical signal and outputting the multiplexed signal to the optical fiber link; and
a second multiplexer/demultiplexer in the second node for demultiplexing the first check light and the data-modulated optical signal received from the first multiplexer/demultiplexer via the optical fiber link.

13. A method for monitoring an optical fiber link linking a first node and a second node, the method comprising:
outputting a first check light by a first transmitting part, which is modulated by a first pattern signal, to a optical fiber link;
receiving and demodulating a second pattern signal from a second check light received from the optical fiber link by a first receiving part; and
generating the first pattern signal by a first processor and outputting the first pattern signal to the first transmitting part, and the first processor receiving the second pattern signal from the first receiving part.

14. The method according to claim 13, further comprising modifying at least one of the first pattern signal and second pattern signal when a predetermined bit error rate has been reached.

15. The method according to claim 13, further comprising detecting by the first processor a length of the optical fiber link by calculating an elapsed time between a time of outputting the first pattern signal and a time of receiving the second pattern signal.
